(19) United States
(12) Patent Application Publication
(10) Pub. No.: US 2012/0289228 A1
(43) Pub. Date: Nov. 15, 2012

(54) AV Avatar System and Method for Interacting with Mobile Device

(76) Inventor: Marc Celis, Namur (BE)

(21) Appl. No.: 13/469,216

(22) Filed: May 11, 2012

Related U.S. Application Data
(60) Provisional application No. 61/485,754, filed on May 13, 2011.

(51) Int. Cl. H04W 4/02

(52) U.S. Cl. 455/435.1

(57) ABSTRACT

The present invention provides a system for use with a first communication device and a second communication device. The first communication device can provide a first registration communication, whereas the second communication device can provide a second registration communication and a location communication. The system includes a communication portion, a registration portion, a memory portion and a location portion. The communication portion can receive the first registration communication, the second registration communication and the location communication. The registration portion can generate first registration information based on the first registration communication and generate second registration information based on the second registration communication. The memory portion can store the first registration information and the second registration information. The location portion can generate location information based on the location communication, the first registration information and the second registration information. The communication portion can transmit the location information to the first communication device.

The present application claims priority from U.S. Provisional Application No. 61/485,754 filed May 13, 2011, the entire disclosure of which is incorporated herein by reference.

### BACKGROUND

The present invention relates to communication systems and social networking.

In some conventional social networking systems mobile communication devices may be used. In particular, in some conventional communication systems a person may be able to communicate with many people within an address list stored on a mobile communication device. Still further, some social networking services may allow a person with a mobile device to “post” their location, for others within the social network.

A social network typically may be implemented in a conventional communication system.

FIG. 1 illustrates a conventional communication system.

As shown in the figure, a communication system 100 includes a communication network 102. A plurality of users, a sample of which is indicated here as a user 112, a user 114 and a user 116, can connect to communication network 102. Users 112, 114 and 116 are located in a region 110.

Communication system 100 includes a cellular network 104, a public switched telephone network (PSTN) 105, a satellite network 106 and a global communication network 108.

As a non-limiting example, global communication network 108 may be configured as the Internet.

User 112 includes a device 118, user 114 includes a device 120 and user 116 includes a device 122.

Region 110 can include any geographic area in which users 112, 114 and 116 are able to communicate with one another using devices 118, 120 and 122.

Global communication network 108 is able to bidirectionally communicate with cellular network 104, PSTN 105 and satellite network 106. Cellular network 104 is able to bidirectionally communicate with PSTN 105 and satellite network 106. PSTN is additionally able to bidirectionally communicate with satellite network 106. Cellular network 104, PSTN 105, satellite network 106 and global communication network 108 are able to communicate with users 112, 114 and 116. So for purposes of explanation and brevity, users 112, 114 and 116 arc able to communicate with communication network 102

Cellular network 104 is a radio network distributed over land areas called cells, and when joined together these cells provide radio coverage over a wide geographic area. This enables a large number of portable devices (mobile phones, pagers, etc.) to communicate with one another and with fixed devices and telephones associated with the network.

PSTN 105 is a network of telephone lines, fiber optic cables and microwave transmission links, all inter-connected by switching centers, thus allowing any telephone in the world to communicate with any other.

Satellite network 106 is a system of satellites either fixed in space (e.g. geosynchronous satellites) or in orbit around the earth at low altitudes (e.g. low earth orbit satellites).

Global communication network 108 is a global system of interconnected computer networks, consisting of millions of private, public, academic, business and government networks connected by a broad array of electronic, wireless and optical networking technologies.

In order to connect with communication network 102, users 112, 114 and 116 utilize devices 118, 120 and 122, respectively. As a non-limiting example, devices 118, 120 and 122 may include cellular telephones, satellite telephones, computers, or other devices that can be used to access cellular network 104, PSTN 105, satellite network 106 and global communication network 108 of communication network 102.

In operation, user 112 may seek to use device 118 (e.g. cellular phone) to contact device 120 (e.g. computer) of user 114. User 112 may use device 118 to connect with cellular network 104 of communication network 102. The call may then be routed from cellular network 104 to global communication network 108, then from global communication network 108 to device 120 of user 114 in order to complete the connection.

In conventional systems, in order to find other users within region 110, users 112, 114, and 116 actively connect to a network and actively search for other users. This will be further described with reference to FIG. 2.

FIG. 2 illustrates an example method 200 by which the users of FIG. 1 make a connection.

As shown in FIG. 2, method 200 starts (S201) and a user connects with a network (S202).

For example, returning to FIG. 1, user 112 is within region 110, and connects with communication network 102 using device 118. In this example, device 118 is configured as a cellular phone and therefore connects with cellular network 104.

Returning to FIG. 2, user then actively searches for another user (S204).

For example, user 112 may use online tools such as websites or chat rooms, or a cellular phone application in order to search for another user.

If another user is found (Yes at S206), user 112 then determines whether the other user is within region 110 (S208).

For example, returning to FIG. 1, user 112 finds user 114 using an online tool, and then determines that user 114 is within region 110.

Returning to FIG. 2, user 112 then actively connects to user 114 (S210) by calling, texting, emailing, or any other viable communication method. At that point, method 200 ends (S212).

If another user is not found in the initial search by user 112 (No at S206), the search is stopped (S214).

For example, user 112 does not continue to search for other users and method 200 ends (S212).

If another user is found, but is not within region 110 (No at S208), then the second user is not contacted (S216). For example, user 112 does not continue to search for other users and method 200 ends (S212).

What is needed is a system and method for searching for, and connecting with, other users within a specific region.

### BRIEF SUMMARY

The present invention provides a system and method for searching for, and connecting with, other users within a specific region.

The present invention provides a system for use with a first communication device and a second communication device. The first communication device can provide a first registration communication, whereas the second communication device can provide a second registration communication and a location communication. The system includes a communication portion, a registration portion, a memory portion and a location portion. The communication portion can receive the first registration communication, the second registration communication and the location communication. The registration portion can generate first registration information based on the first registration communication and generate second registration information based on the second registration communication. The memory portion can store the first registration information and the second registration information. The location portion can generate location information based on the location communication, the first registration information and the second registration information. The communication portion can transmit the location information to the first communication device.

Additional advantages and novel features of the invention arc set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a conventional communication system;

FIG. 2 illustrates a method by which the users of FIG. 1 make a connection;

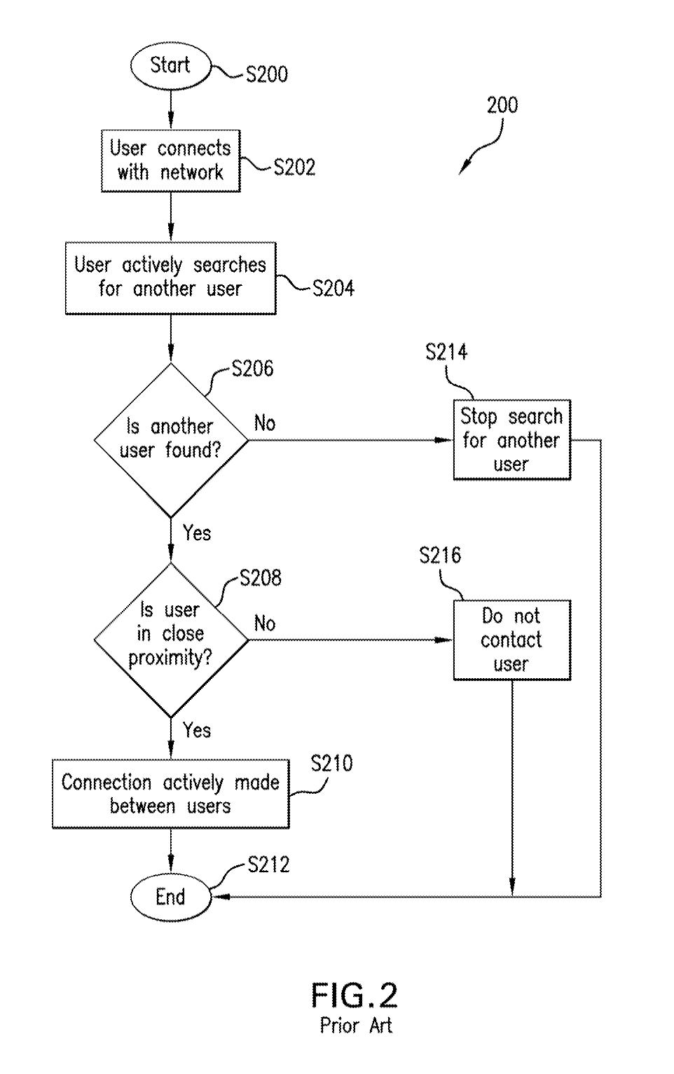

FIG. 3 illustrates a communication system in accordance with aspects of the present invention;

FIG. 4 illustrates an exploded view of an example communication device of FIG. 3;

FIG. 5 illustrates an exploded view of an example central server of FIG. 3;

FIG. 6 illustrates an attempt to open a connection between users;

FIG. 7 illustrates an example method by which the connection of FIG. 6 is requested;

FIG. 8 illustrates an example method by which the connection request of FIG. 6 is evaluated;

FIG. 9 illustrates an attempt to open a connection between users; and

FIG. 10 illustrates an example method by which the connection of FIG. 9 is requested.

### DETAILED DESCRIPTION

The present invention is drawn to a communication system that can connect users with similar interests. Users upload registration information, non-limiting example of which include user name, password, contact information, information regarding personal interests, and any other information deemed relevant by the user, to a central server. The communication system then surveys the local region and determines if there are other users in the region that would be a good match, and then the system provides notification of the match.

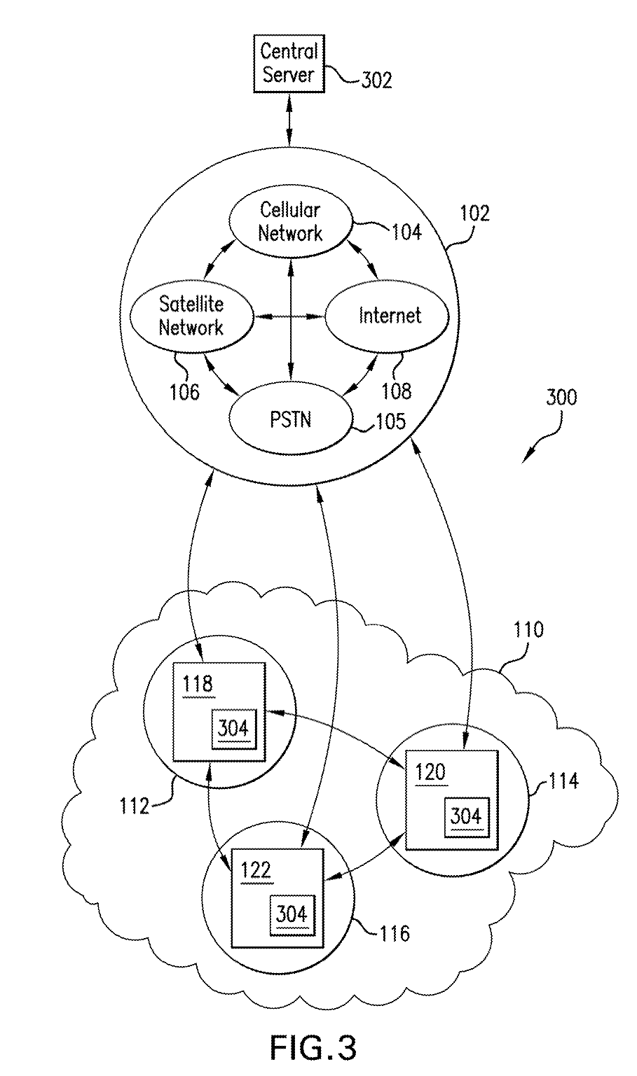

Aspects of the present invention as discussed above will now be further described in greater detail with reference to FIGS. 3-8.

FIG. 3 illustrates an example communication system, in accordance with aspects of the present invention.

As shown in the figure, a communication system 300 includes communication network 102, a central server 302 and a plurality of users located in region 110, a sample of which is indicated here as users 112, 114 and 116.

Central server 302 is arranged to bidirectionally communicate with communication network 102.

Users 112, 114 and 116 include devices 118, 120 and 122, respectively.

Devices 118, 120 and 122 include a respective controller 304.

Central server 302 serves as a repository of information for users that have registered accounts. Users upload information to central server 302 during a registration process, and the information can be accessed as needed. In addition, information can be added or removed from central server 302 as needed even after the registration process is complete.

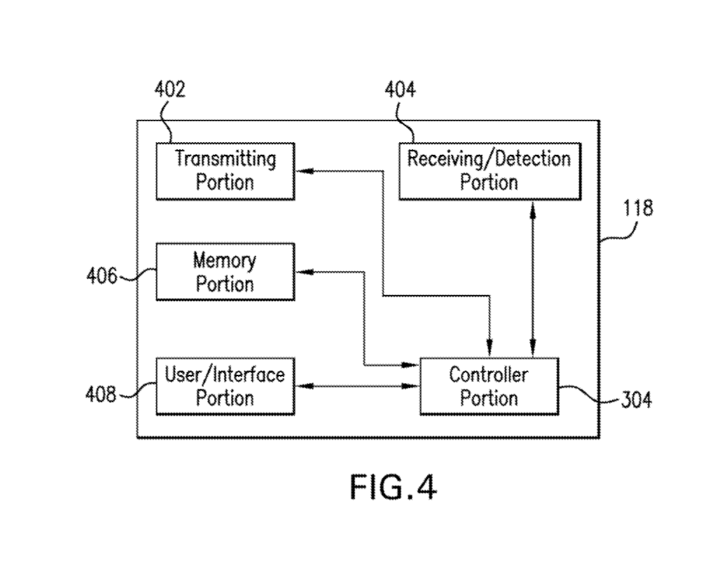

FIG. 4 illustrates an exploded view of an example communication device of FIG. 3, in accordance with aspects of the present invention.

As shown in FIG. 4, device 118 includes a transmitting portion 402, a receiving/detection portion 404, a memory portion 406, a user interface portion 408 and controller 304. In this example, transmitting portion 402, receiving/detection portion 404, memory portion 406, user interface portion 408 and controller 304 are distinct elements. However, in some embodiments, at least two of transmitting portion 402, receiving/detection portion 404, memory portion 406, user interface portion 408 and controller 304 may be combined as a unitary element. In other embodiments, at least one of transmitting portion 402, receiving/detection portion 404, memory portion 406, user interface portion 408 and controller 304 may be implemented as a computer having stored therein tangible, non-transitory, computer-readable media for carrying or having computer-executable instructions or data structures stored thereon. Such tangible, non-transitory, computer-readable media can be any available media that can be accessed by a general purpose or special purpose computer. Non-limiting examples of tangible, non-transitory, computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a tangible, non-transitory, computer-readable medium. Combinations of the above may also be included within the scope of tangible, non-transitory, computer-readable media.

Controller 304 is operable to bidirectionally communicate with transmitting portion 402, receiving/detection portion 404, memory portion 406 and user interface portion 408.

Transmitting portion 402 receives information from controller 304 and sends the information from device 118 to another device via cellular network, satellite network, the Internet or a Bluetooth network. Additionally, transmitting portion 402 may notify controller 304 when information is being transmitted and when there is no information being transmitted.

Receiving/detection portion 404 provides information to controller 304 for further processing. The information can be received via cellular network, PSTN, satellite network, the Internet or a Bluetooth network. Additionally, controller 304 may notify receiving/detection portion 404 of the appropriate time(s) to receive or detect incoming information.

Memory portion 406 is operable to save information provided to controller 304 that is for future interactions. Memory portion 406 may be long term or short term memory. Long term memory would store the information after controller 304 is closed on device 118, while short term memory stores information while controller 304 is operating on device 118.

User interface portion 408 is operable to bidirectionally communicate with user 112. User 112 activates controller 304 on device 118 via user interface portion 408. In addition, user 112 may input information to controller 304 via user interface portion 408 that is either stored in memory portion 406 or is transmitted via transmitting portion 402. Information may include modifying current user settings, inputting new user data, or any other information that user 112 may deem useful in helping controller 304 find potential connections. Information may be input by typing, but it may also be input via voice input, as controller 304 may include voice recognition technology. In addition, information provided to the user from controller 304 may be in the form of text on a screen, but it may also be in the form of a spoken voice, as controller 304 may include speech technology.

Controller 304 is operable to provide information to the user regarding other users operating a similar controller 304 located on other devices, and making suggestions as to how to interact with such other users.

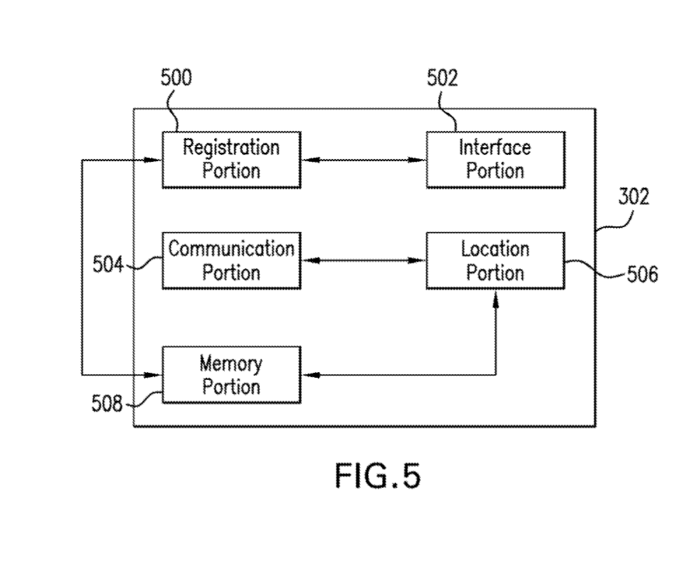

FIG. 5 illustrates an exploded view of an example central server of FIG. 3, in accordance with aspects of the present invention.

As shown in the figure, central server 302 includes a registration portion 500, an interface portion 502, a communication portion 504, a location portion 506 and a memory portion 508. In this example, registration portion 500, interface portion 502, communication portion 504, location portion 506 and memory portion 508 are distinct elements. However, in some embodiments, at least two of registration portion 500, interface portion 502, communication portion 504, location portion 506 and memory portion 508 may be combined as a unitary element. In other embodiments, at least one of registration portion 500, interface portion 502, communication portion 504, location portion 506 and memory portion 508 may be implemented as a computer having stored therein tangible, non-transitory, computer-readable media for carrying or having computer-executable instructions or data structures stored thereon.

Registration portion 500 is operable to bidirectionally communicate with interface portion 502 and memory portion 508. Communication portion 504 is operable to bidirectionally communicate with location portion 506 and memory portion 508. Location portion 506 is operable to bidirectionally communicate with memory portion 508.

Registration portion 500 is operable to receive registration communications provided to interface portion 502 and complete a registration process. During the registration process, the user transmits a registration signal to registration portion 500 via interface portion 502. The registration signal may be sent via any known communication method where information can be provided, non-limiting examples of which include text messaging, email or via a graphic user interface (GUI) on a mobile device. Registration portion 500 takes the various registration information included with the registration signal and stores it in memory portion 508.

For example, registration portion 500 may include a lookup table that includes numerous data portions. One data portion, for example, may include a user ID and password that is chosen by the user during the registration process. The user ID is a unique identifier that can be assigned to only one user, and is used by the user to update or modify information entered during the registration process.

Another data portion may include the contact information the user would like to associate with the chosen user ID. For example, the user may register home, office and mobile phone numbers, personal and work e-mail addresses, and any other means by which the user could be contacted.

Another portion may include information regarding the hobbies of the user or activities in which the user likes to participate, or other various likes/dislikes of the user that may streamline the process of connecting with other users.

Another data portion may include the daily calendar of the user, along with information regarding the location of the user at various times. Access to the calendar is provided to registration portion 500 by the user, and the calendar may be synced with registration portion 500 as specified by the user.

Another data portion may include the services available to the user, and the services in which the user actively participates. Services may include e-mail, text messaging, picture messaging, phone calls, video phone calls, Internet usage, and other services that facilitate communication between users.

The data portions discussed above are non-limiting examples provided for purposes of discussion.

Interface portion 502 is operable to receive information from a device. Information may include modifying current user settings, inputting new user data, or any other information that a user may deem useful in aiding controller 304 find potential connections.

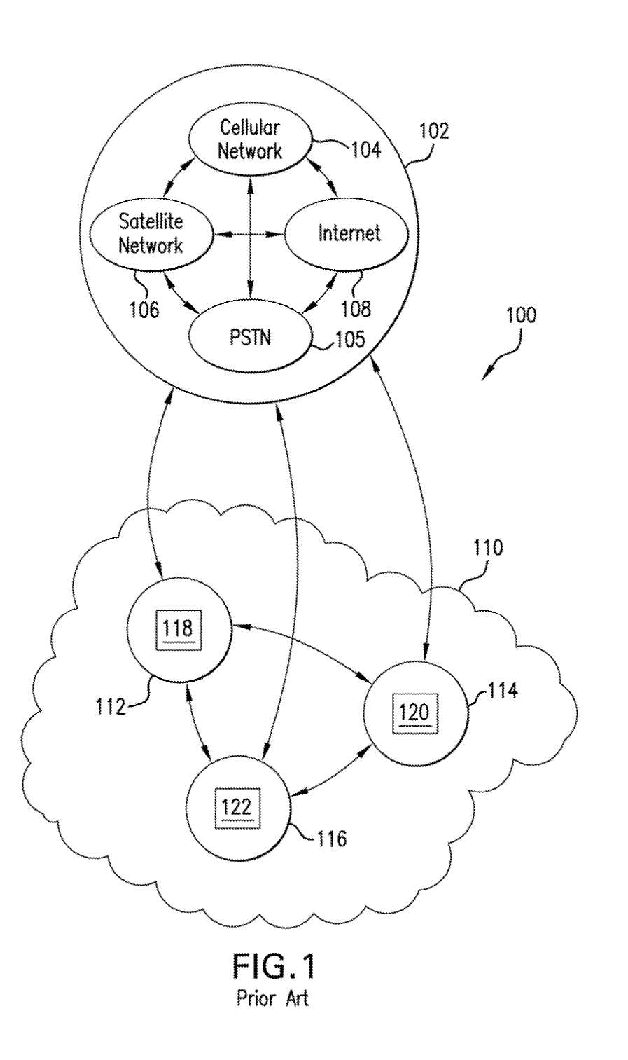

Communication portion 504 is operable to receive information from communication network 102 of FIG. 1 and provide the information to location portion 506 and memory portion 508. Additionally, communication portion 504 is operable to receive information from location portion 506 and memory portion 508 and broadcast that information through communication network 102 of FIG. 1.

Location portion 506 is operable to receive and transmit information regarding the geodetic location of a device associated with a user. A location communication for any device is provided to location portion 506 via communication portion 504. The device determines its own geodetic position (via GPS, WIFI, or any other known positioning system), and then transmits a communication regarding its physical location to communication portion 504, which then passes the information along to location portion 506. Location portion 506 may store the location communication in memory portion 508. Thus, central server 302 may hold a repository of information regarding the physical location of any device within communication network 102 that transmits its physical location via a location communication. Location communications may be updated as frequently or infrequently as the user desires, however it may be needed for location information to be updated frequently in order for central server 302 to maintain accurate location information regarding users.

Memory portion 508 is operable to save information provided to controller 304 and sent to communication portion 504 or interface portion 502 of central server 302. Information may include modifying current user settings, inputting new user data, or any other information that a user may deem useful in helping controller 304 find potential connections.

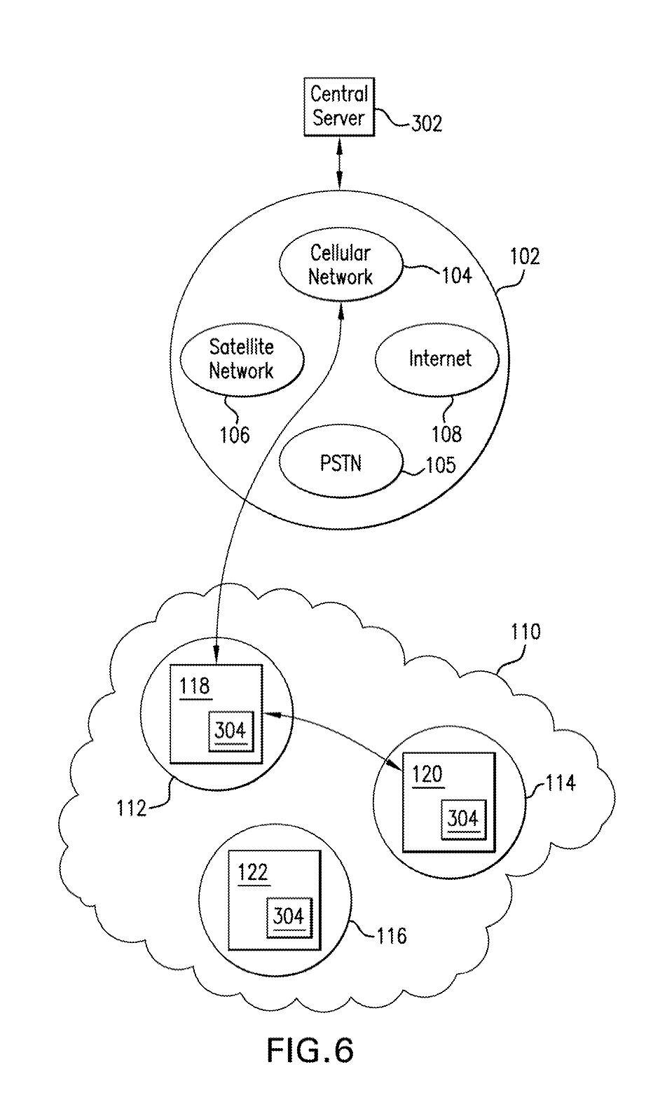

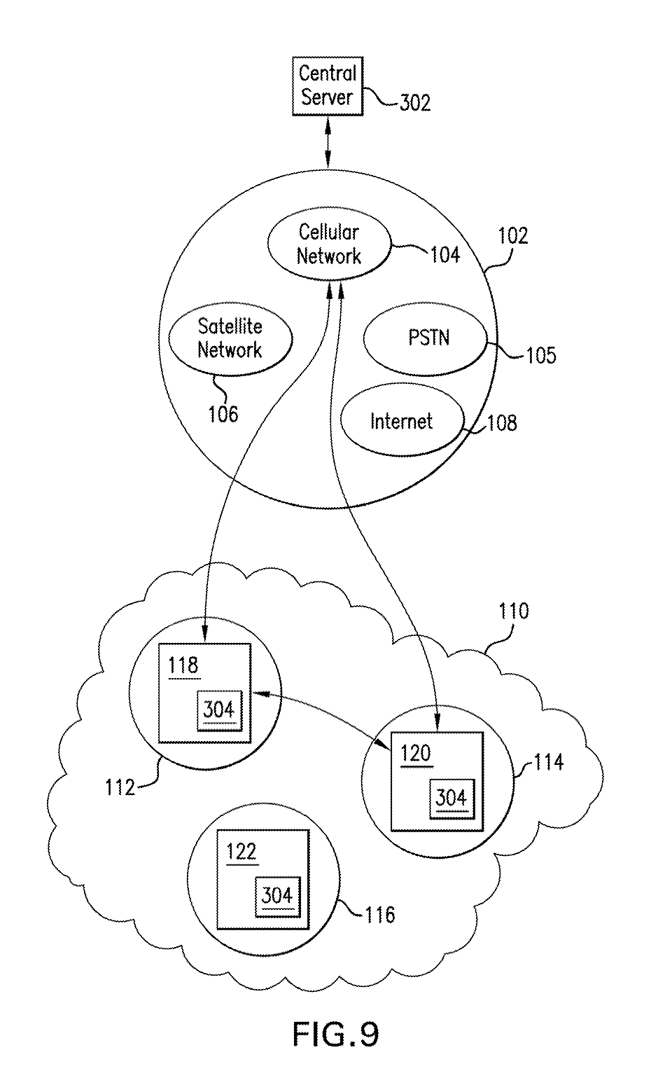

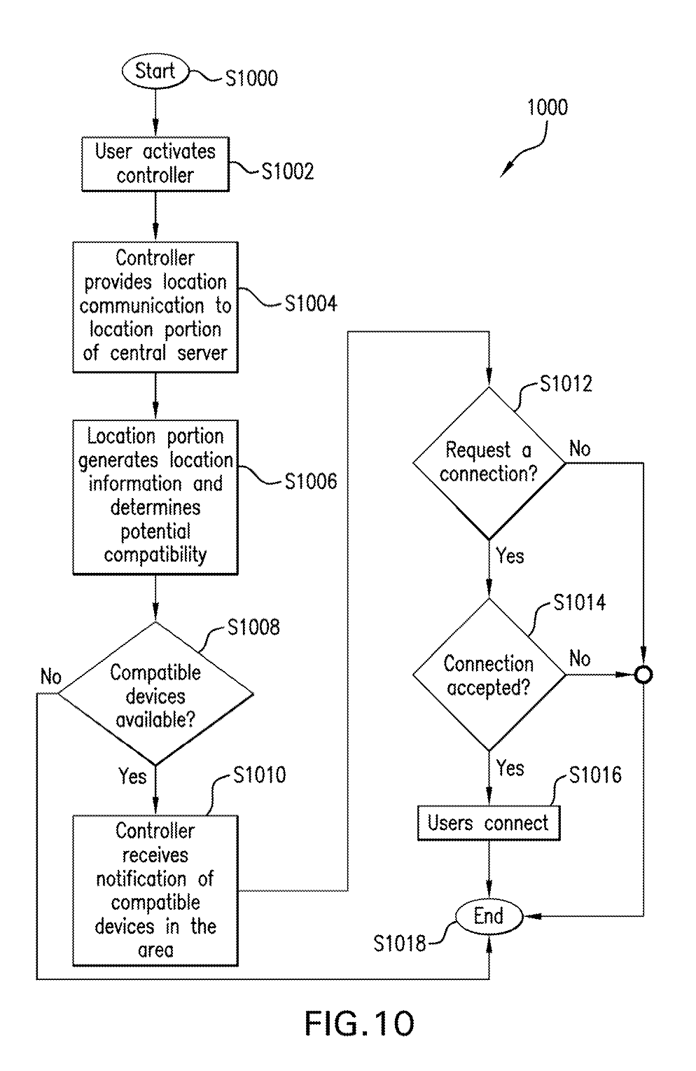

In operation, user 112 may be located in the same region 110 as user 114 as described above with reference to FIG. 3. User 112 may turn on device 118 and activate controller 304. User 114 may turn on device 120 and activate controller 304. Without users 112 and 114 being aware of each other, devices 118 and 120 become aware of one another and determine whether there arc compatibilities between users 112 and 114. If there are compatibilities, controller 304 notifies users 112 and 114 of the compatibility and makes a recommendation to connect. Devices 118 and 120 can become aware of the other device in various ways. One way in which devices 118 and 120 can become aware of the other is through local communications, a non-limiting example of which includes Wi-Fi, in which devices that are geographically near one another can send and receive signals. If local communications are utilized, central server 302 is not involved in determining the proximity of users. Another way in which devices 118 and 120 can become aware of one another is through global communications such as communication network 102. If global communications are utilized, central server 302 is involved in determining the proximity of users. The process utilizing local communications will be further described with reference to FIGS. 6-8. The process utilizing global communications will be further described with reference to FIGS. 9-10.

FIG. 6 illustrates an attempt to open a connection between users 112 and 114, in accordance with aspects of the present invention.

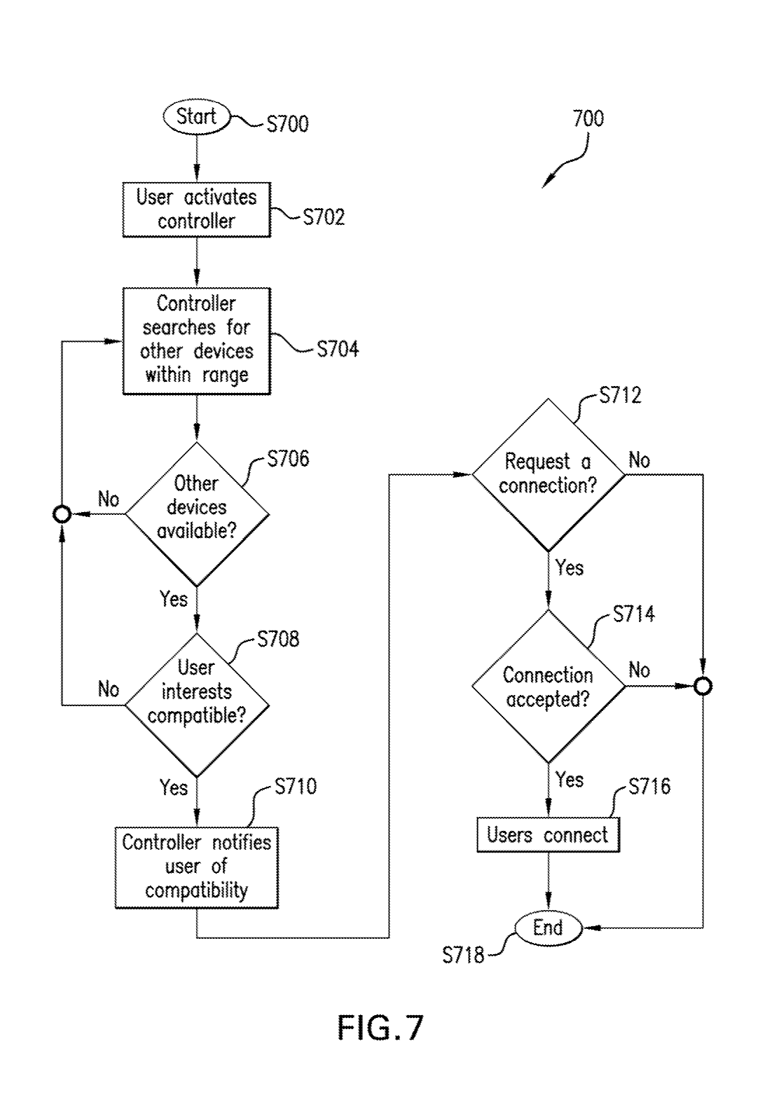

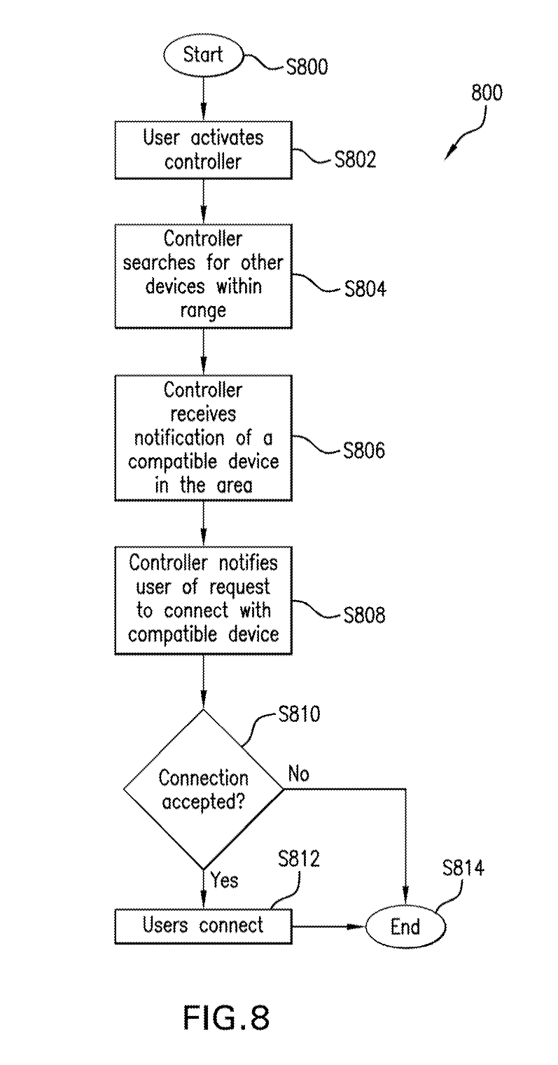

As shown in FIG. 6, users 112 and 114 arc located in the same region 110. Users 112 and 114 have devices 118 and 120, respectively, and the devices have activated controller 304. Device 118 determines that device 120 is located within region 110 by utilizing a local Bluetooth network. The determination could be made using other networks, and the Bluetooth network is one example. Device 118 (in this case, a cellular phone), contacts central server 302 via cellular network 104 in order to receive more information regarding device 120 and user 114 associated with device 120. Contact could also be made via other networks; however for this example cellular network 104 is used. Device 118 learns more about device 120 and user 114 from central server 302, and makes the determination that user 112 is to be notified of a potential match in interests between users 112 and 114. After notification, users 112 and 114 may connect via devices 118 and 120, or in person. This process will be further described with reference to FIGS. 7-8.

FIG. 7 illustrates an example method by which the connection of FIG. 6 is requested, in accordance with aspects of the present invention.

Returning to FIG. 6, a method 700 starts (S701) and users 112 and 114 activate controller 304 (S702) on devices 118 and 120, respectively.

Returning to FIG. 4, controller 304 instructs transmitting portion 402 of device 118 to broadcast a signal that would notify other devices of its presence in the region. The signal may be broadcast via Bluetooth, wireless Internet, or any other signal that may be operable to notify other devices of its presence in the region. Controller 304 also instructs receiving/detection portion 404 to search for signals of other devices that are present in the region (S704).

Returning to FIG. 6, controller 304 on device 118 determines that device 120 is located within region 110 (Yes at S706) after receiving/detection portion 404 receives a signal from device 120. The signal from device 120 includes identification information about device 120 and user 114. Controller 304 then instructs transmitting portion 402 to contact central server 302 of FIG. 5 via cellular network 104.

If no other devices are located within region 110 (No at S706), controller 304 again instructs receiving/detection portion 404 to search for signals of other devices that are present in the region (S704).

Returning to FIG. 5, communication portion 504 of central server 302 receives a communication from device 118 which includes identification information about device 118 and user 112, and about device 120 and user 114. The communication requests information regarding the profiles of users 114 and 112. Communication portion 504 relays the request to memory portion 508, and memory portion 508 retrieves the requested information, relays the information to communication portion 504, and communication portion 504 sends the information back to device 118 via cellular network 104 of FIG. 6.

Returning to FIG. 4, receiving/detection portion 404 receives the communication regarding the profiles of users 112 and 114 and sends the information to controller 304. Controller 304 then compares the profiles of the users and determines whether or not the interests of the users are compatible (S708).

If user interests are not compatible (No at S708), controller 304 again instructs receiving/detection portion 404 to search for signals of other devices that are present in the region (S704). For example, user 112 may be interested in finding accounting services, and user 114 may have nothing in his profile that would indicate user 114 has any experience with accounting services. In this example case, the user interests are not compatible.

Returning to FIG. 4, if the user interests are compatible (Yes at S708), controller 304 sends a message to user 112 via user interface portion 408 to notify user 112 that user 114 is close by and shares similar interests (S710). For example, user 112 may be interested in finding accounting services, and user 114 may have just started an accounting services business and is looking to generate business and find new clients. In this case, the interests of users 112 and 114 are compatible. The message to user 112 regarding the compatibility with user 114 may be via text on the screen of device 118, but it may also be via a spoken message if controller 304 and device 118 are equipped with speech software. The message may also pop up on the screen of device 118 via a GUI. The message may include full details of the profile of user 114, including information regarding his accounting services and the specific location of user 114, and even a map showing the location of user 112 relative to user 114, to aid user 112 to physically locate user 114, if desired.

Returning to FIG. 6, user 112 receives the notification and determines whether or not to connect with user 114 (S712).

If user 112 decides to connect with user 114 (Yes at S712), then a connection request is sent either from device 118 of user 112 to device 120 of user 114, or user 112 may physically locate user 114 and request to connect in that manner (S714).

If user 112 decides not to connect with user 114, then a connection is not made and method 700 ends (S716).

If user 114 accepts the request to connect with user 112 (Yes at S714), then user 114 and user 112 connect either face to face or via text message, email, phone call, or any other communication method that would provide a connection (S716), and method 700 ends (S718).

If user 114 rejects the request to connect with user 112 (No at S714), then user 114 and user 112 do not connect, and method 700 ends (S718).

As a user interacts more and more with controller 304, more and more preferences of the user can be stored in memory portion 508 of central server 302. As the data set of preferences becomes larger, controller 304 can make better decisions as to what the user seeks to do and with whom the user wants to connect. In this manner, controller 304 can learn, as time goes on, and provide the user with even better recommendations based on the results of past recommendations.

FIG. 8 illustrates an example method by which the connection request of FIG. 6 is evaluated, in accordance with aspects of the present invention.

Returning to FIG. 6, a method 800 starts (S801) and users 112 and 114 activate controller 304 (S802) on devices 118 and 120, respectively.

Controller 304 instructs the transmitting portion of device 120 to broadcast a signal that would notify other devices of its presence in the region. The signal may be broadcast via Bluetooth, wireless Internet, or any other signal that may be operable to notify other devices of its presence in the region. Controller 304 also instructs the receiving/detection portion of device 120 to search for signals of other devices that are present in the region (S804).

Controller 304 on device 120 receives notification from controller 304 on device 118 that user 112 may be matched well with user 114 (S806). The notification from device 118 includes profile information on user 112. Returning to the previous example scenario, the notification from device 118 may include information regarding the desire of user 112 to find the accounting services that user 114 may be able to provide.

Controller 304 of device 120 then sends a message to user 114 to notify user 114 that user 112 is close by and shares similar interests (S808). The message may be via text on the screen of device 120, but it may also be via a spoken message if controller 304 and device 120 are equipped with speech software, or via a GUI. The message may include full details of the profile of user 112, including the specific location of user 112 and a map of the locations of user 114 and user 112 to aid user 114 to physically locate user 112, if desired.

User 114 receives the notification and determines whether or not to connect with user 112 (S810).

If user 114 decides to connect with user 112 (Yes at S810), then the request to connect is accepted and a connection may be made either from device 120 of user 114 to device 118 of user 112, or user 114 may physically locate user 112 and connect in that manner (S812). Method 800 ends (S814).

If user 114 decides not to connect with user 112 (No at S810), then the request to connect is rejected and a connection is not made and method 800 ends (S814).

FIG. 9 illustrates an attempt to open a connection between users, in accordance with aspects of the present invention.

As shown in FIG. 9, users 112 and 114 are located in region 110. Users 112 and 114 have devices 118 and 120, respectively, and the devices have activated controller 304. Devices 118 and 120 provide location communications to central server 302 via cellular network 104. Device 118 receives notification that device 120 is located within region 110 by communicating with central server 302 via cellular network 104. The determination could be made using other networks, a non-limiting example of which includes cellular network 104. Central server 302 contacts device 118 (in this case, a cellular phone) via cellular network 104 in order to provide more information regarding device 120 and user 114 associated with device 120. Contact could also be made via other networks; however for this example cellular network 104 is used. Device 118 receives information about device 120 and user 114 from central server 302, and notifies user 112 of a potential match in interests between users 112 and 114. After notification, users 112 and 114 may connect via devices 118 and 120, or in person. This process will be further described with reference to FIGS. 10-11.

FIG. 10 illustrates an example method by which the connection of FIG. 9 is requested and executed, in accordance with aspects of the present invention.

Starting with FIG. 10, a method 1000 starts (S1001) and users 112 and 114 activate controller 304 (S1002) on devices 118 and 120; respectively.

Returning to FIG. 4, controller 304 instructs transmitting portion 402 of device 118 to transmit a location communication to location portion 506 of central server 302 to provide location portion 506 information regarding the physical location of device 118 (S1004). In a similar fashion, device 120 transmits a location communication to location portion 506 of central server 302 to provide location portion 506 information regarding the physical location of device 120. Information regarding the physical location of devices 118 and 120 is determined via known positioning systems within the devices, such as GPS or Wi-Fi, and transmitted to central server 302 via any suitable communication means within communication network 102.

Returning to FIG. 5, location portion 506 generates, location information based on the location communications it receives and registration information previously provided to central server 302 and stored in memory portion 508 (S1006). For example, location portion 506 may receive communications that show devices 118 and 120 are in the same geographic location. Location portion 506 would then access memory portion 508 and compare the registration information associated with devices 118 and 120 to determine whether or not there are any compatibilities to be explored. In an example scenario, user 112 may be looking for accounting services and user 114 may have just opened an accounting services business, and they happen to be shopping in the same mall at the same time. Users 112 and 114 may activate controllers 304 on communication devices 118 and 120, respectively, which then transmit their physical location to location portion 506 of central server 302. Location portion 506 then learns that user 112 and user 114 may meet as a result of having a mutual interest in accounting services and are located in close proximity to one another.

If no compatible devices arc in the same area (No at S1008), no further action is taken by location portion 506 and method 1000 ends (S1018).

If one or more compatible devices arc in the same area (Yes at S1008), location portion 506 instructs communication portion 504 to send a communication to controllers 304 of the compatible devices within the same geographic region. In the example scenario, a communication is sent to devices 118 and 120 to notify users 112 and 114, respectively, that there is someone with compatible accounting services interests nearby.

Returning to FIG. 10, the controllers of the compatible devices receive notification that there are other compatible devices in the area (S1010). The notification may be in the form of a text message, an email, or a pop up screen on a GUI of the device. The notification may include full details of the profiles of users 112 and 114, including information regarding the accounting services sought and services offered, and the specific locations of user 112 and 114, and even a map showing the locations of the users, to aid users 112 and 114 to physically locate one another, if desired.

Once the information is received by users 112 and 114 the users determine whether or not there is a desire to connect with one another (S1012).

If, for example, user 112 decides to connect with user 114 (Yes at S1012), then a connection request is sent either from device 118 of user 112 to device 120 of user 114, or user 112 may physically locate user 114 and request to connect in that manner. The decision to connect may originate from user 114 as well, however for purposes of explanation and brevity, the decision to connect is described as originating from user 112.

If user 112 decides not to connect with user 114 (No at S1012), then a connection is not made and method 1000 ends (S1018).

If user 114 accepts the request to connect with user 112 (Yes at S1014), then user 114 and user 112 connect either face to face or via text message, email, phone call, or any other communication method that would provide a connection (S1016), and method 1000 ends (S1018).

If user 114 rejects the request to connect with user 112 (No at S1014), then user 114 and user 112 do not connect, and method 1000 ends (S1018).

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as arc suited to the particular use contemplated. It is intended that the scope of the invention be defined by the claims appended hereto.

What is claimed as new and desired to be protected by Letters Patent of the United States is:

1. A system for use with a first communication device and a second communication device, the first communication device being operable to provide a first registration communication, the second communication device being operable to provide a second registration communication and a location communication, said system comprising:
a communication portion operable to receive the first registration communication, the second registration communication and the location communication;
a registration portion operable to generate first registration information based on the first registration communication and to generate second registration information based on the second registration communication;
a memory portion operable to store the first registration information and the second registration information; and
a location portion operable to generate location information based on the location communication, the first registration information and the second registration information,
wherein said communication portion is operable to transmit the location information to the first communication device.

2. The system of claim 1, wherein said registration portion is operable to generate the first registration information as one of a user name, a password, contact information, and information regarding personal interests.

3. A communication device for use with a system and a second communication device, the system being operable to receive a first registration communication, the second communication device being operable to provide a second registration communication and a location communication, the system being further operable to receive the second registration communication and the location communication and to transmit location information, said communication device comprising:
a transmitting portion operable to transmit the first registration communication;
a receiving portion operable to receive the location information;
a location portion operable to determine a communication device location; and
a control portion operable to determine a location of the second communication device based on the location information.

4. The system of claim 3, wherein said location portion is operable to generate the location information by way of GPS or WiFi positioning systems.

5. A method of using a first communication device and a second communication device, the first communication device being operable to provide a first registration communication, the second communication device being operable to provide a second registration communication and a location communication, said method comprising:
receiving, via a communication portion, the first registration communication;
receiving, via the communication portion, the second registration communication;
receiving, via the communication portion, the location communication;
generating, via a registration portion, first registration information based on the first registration communication;
generating, via the registration portion, second registration information based on the second registration communication;
storing, via a memory portion, the first registration information;
storing, via the memory portion, the second registration information;
generating, via a location portion, location information based on the location communication, the first registration information and the second registration information; and
transmitting, via the communication portion, the location information to the first communication device.

6. The method of claim 5, wherein said generating, via a registration portion, first registration information based on the first registration communication comprises generating the first registration information as one of a user name, a password, contact information, and information regarding personal interests.

7. A method of using a system and a second communication device, the system being operable to receive a first registration communication, the second communication device being operable to provide a second registration communication and a location communication, the system being further operable to receive the second registration communication and the location communication and to transmit location information, said method comprising:
transmitting, via a transmitting portion, the first registration communication;
receiving, via a receiving portion, the location information;
determining, via a location portion, a communication device location; and
determining, via a control portion, a location of the second communication device based on the location information.

8. The system of claim 7, wherein said determining, via a location portion, a communication device location comprises generating the location information by way of GPS or WiFi positioning systems.
